(19) United States
(12) Patent Application Publication
(10) Pub. No.: US 2016/0343471 A1
(43) Pub. Date: Nov. 24, 2016

(54) ELECTRICAL CABLE AND METHOD FOR PRODUCING AN ELECTRICAL CABLE BUNDLE

(71) Applicants: LEONI BORDNETZ-SYSTEME GMBH, KITZINGEN (DE); LEONI KABEL HOLDING GMBH, NUERNBERG (DE)

(72) Inventors: CHRISTIAN ERNST, WEISSENBURG (DE); WOLFGANG HAUSCHILD, ZIRNDORF (DE); JULIAN HIEMER, WINTERHAUSEN (DE); STEFAN KRUG, ROTTENDORF (DE); WOLFGANG LANGHOFF, LEONBERG (DE); MARCO PREUSS, WUERZBURG (DE)

(21) Appl. No.: 15/228,190

(22) Filed: Aug. 4, 2016

Related U.S. Application Data
(63) Continuation of application No. PCT/EP2015/052097, filed on Feb. 2, 2015.

(30) Foreign Application Priority Data
Feb. 4, 2014 (DE) 102014201992.3

(51) Int. Cl. H01B 7/40; H01B 11/02; H01B 13/02; H01B 11/00; H01B 13/22; H01B 7/18

(52) U.S. Cl. CPC H01B 7/40; H01B 13/228; H01B 7/18; H01B 13/0214; H01B 11/002; H01B 11/02

(57) ABSTRACT

An electrical cable contains a cable bundle formed by at least two single wires, each containing a conductor surrounded by insulation. An adhesive layer is applied to all single wires, surrounding the insulator in a ring-like manner, via which the single wires are adhered to one another. The cable bundle does not also contain a cable sheath surrounding the cable bundle. The adhesive layer is formed by a reactive coating that is cured after activation so that a thermally stable connection can be achieved. The cable bundle is formed by single wires that are twisted with one another, and which are used, as a data line. This structure, with the adhesive layer, removes the need for a cable sheath so that a more compact structure can be achieved. The form lay length of the cable bundle is fixed, having a positive effect on the transmission characteristics for a data line.

### CROSS-REFERENCE TO RELATED APPLICATION

This is a continuation application, under 35 U.S.C. §120, of copending international application No. PCT/EP2015/052097, filed Feb. 2, 2015, which designated the United States; this application also claims the priority, under 35 U.S.C. §119, of German patent application No. DE 10 2014 201 992.3, filed Feb. 4, 2014; the prior applications are herewith incorporated by reference in their entirety.

### BACKGROUND OF THE INVENTION

### Field of the Invention

The invention relates to an electrical cable containing a cable bundle formed by at least two single wires, each single wire having a conductor surrounded by insulation. The single wires are adhered to one another in the end assembled state. The invention further relates to a method for producing an electrical cable bundle of this type.

A cable of this type can be inferred from U.S. Pat. No. 5,734,126 B. The cable serves as a data cable for a high-frequency data transmission. In order to ensure a defined constant distance between two wires of a wire pair, these wires are fixed to one another. In accordance with a first variant the two wires are interconnected here via a web. In accordance with a second variant the two wires are provided at their line of contact with an adhesive. As a third variant, the direct connection of the insulations of the two wires is also provided by a heat treatment. The two wires of the pair are twisted with one another and are usually surrounded as appropriate by a shielding and additionally by a sheath.

U.S. Pat. No. 5,334,271 B likewise relates to twisted wire pairs for a high-frequency data transmission. In order to ensure an identical length of the single wires of the wire pair, the single wires are first fixed to one another in a manner running in parallel. For this purpose, the single wires each have an ePTFE sheath, via which the single wires are sintered to one another. Alternatively, an adhesive tape is wound around the wire insulations. Once fixed in a manner running in parallel, the wire pair is twisted. In so doing, the connection between the single wires is cancelled again.

For many technical fields of application, in particular also in the automotive field, what are known as sheathed cables are used, for example as power cables or as data cables. In the case of a sheathed cable of this type, a plurality of single wires are usually embedded in a common cable sheath. Here, the single wires themselves are insulated conductors. The conductor consists here for example of a solid conductor wire or also of a stranded conductor. This conductor is surrounded by conventional insulation, for example formed of PVC, PP, etc. The additional externally applied cable sheath serves usually as a protective sheath against external influences, for example as mechanical, chemical or also UV protection. A further function of the cable sheath is to hold together the wires so as to enable simple laying. In the case of data cables, the cable sheath additionally serves in particular to maintain the special geometric arrangement of the single wires. These are usually twisted with one another in the case of data cables and have a defined length of lay. In addition, a defined distance between the single wires can be set via the cable sheath in which the single wires are embedded.

In order to form smaller cables of reduced cross-section, a method can be inferred for example from German utility model DE 35 87 183 T2, in which twisted metal conductors are coated by a coating which cures under UV radiation. Further insulating covering layers are applied and cured in the manner of a paint. Enameled wires are usually used for coil windings, etc.

The cable sheath is applied in the conventional manner to the cable bundle usually by an extrusion process, such that the cable sheath directly encases the cable bundle and for example also penetrates the interstices between the single wires, whereby the relative position of the single wires and their geometric distances from one another are fixed.

U.S. patent publication No. 20110284259 A1 describes a method in which a cable sheath is applied to a cable bundle formed by insulated single wires, wherein regions of the single wires still remain visible from outside.

Besides the known sheathed cables with circular cross-section, there are also flat cables or also what are known as ribbon cables, in which case a plurality of single conductors are embedded adjacently in a plane within a common insulation sheath.

Lastly, it is known from published, non-prosecuted German patent application DE 1 704 154 A1 (corresponding to U.S. Pat. No. 3,559,390), in the case of cable twist elements, to adhere these to one another or to hold these together via bands. This serves in particular to avoid what is known as a twisting open, in particular at points at which a change in the direction of lay is made. By way of example, at the points of the change in the direction of lay, a hot-melting, quickly adhering binder is for this purpose sprayed by a nozzle onto the elements that are to be twisted, and thus adheres these to one another. Alternatively, it is proposed in published, non-prosecuted German patent application DE 1 704 154 A1 to weld the insulation of the single wires to one another, more specifically in particular before and after the points of change in the twisting.

### SUMMARY OF THE INVENTION

On this basis, one object of the invention is to specify an electrical cable with low spatial requirement which can be easily produced. A further object of the invention is to specify a method for producing an electrical cable of this type.

The object stated with regard to the electrical cable is achieved in accordance with the invention by an electrical cable. This contains, in the end assembled state, a cable bundle formed by at least two single wires, each single wire containing a conductor surrounded by insulation. An adhesive layer is applied at least to one of the single wires, preferably to both single wires, i.e. to the insulations thereof, via which the two single wires are adhered to one another or are adhered to a support. Here, the adhesive layer consists of an adhesive material (adhesive) applied directly to the insulation of the single wires, said adhesive being formed as an activatable and curable adhesive, which becomes adhesive and/or cures only after an activation. The electrical cable is free here from a cable sheath, that is to say the cable bundle is not embedded in an insulation sheath. The cable is preferably also free from other fixing elements, such as a banding.

This embodiment is based on the consideration, for the geometric fixing of the single wires to one another, of dispensing with a cable sheath or a banding surrounding these, but at the same time providing the function of such a cable sheath as a geometric fixing element in that the single wires are firstly provided with an adhesive coating and are then connected and adhered to one another so that they irreversibly adhere to one another as a whole. Here, as a result of the adhesive layer, a fixing to a support is made possible at the same time or alternatively, such that, where applicable, there is no need for any further fixing elements in order to fasten and guide the cable on a support.

Here, the adhesive layer is directly applied around the circumference of the single wires in the manner of a sheath, preferably as an annular coating. However, it is not necessarily applied here to the single wires as a continuous interruption-free layer. It can be interrupted both in the longitudinal direction and in the circumferential direction. Due to the adhesive layer applied around the circumference, there is no special preferred orientation of the adhesive, and therefore the single wire is adhesive over the entire circumference.

Due to the sheath-like embodiment of the adhesive layer, this layer is in particular formed in the manner of an annular sheath concentric with the single wires with constant layer thickness over the circumference.

Here, the term “directly applied” is understood to mean that the adhesive comes directly into contact with the insulation and for example there is no additional support layer present, as is the case for example when an adhesive tape is wound around the insulation.

The single wires are adhered to one another and/or are adhered on the support in the end assembled state. Here, the term “end assembled” is understood to mean that this is the operating state in which the cable is used in the intended operation, i.e. in particular to guide power or to transmit data. This is therefore not an intermediate state in the production of a cable, for example a sheathed cable, for data transmission.

The use of the special activatable adhesive, which cures, has the crucial advantage that the adhesive layer, once cured, is no longer adhesive. This is essential since the cable is a sheath-free cable and otherwise the adhesive layer would be disrupted during use.

Since the adhesive layer is preferably also adhesive only following an activation, the single wires can be easily handled during the process. The single wires can thus be provided as prefabricated single wires and can be kept ready for subsequent assembly steps. In particular, single wires provided with the as yet inactivated adhesive layer are provided and stored, for example on reels, etc., as pre-assembled single wires. On account of the adhesive layer, which is inactive in the original state, an adhesion or cementing of the adjacently arranged single wires is avoided.

In the present case, the term “activation” is thus understood in particular to mean the initiation of the curing at a defined time. The adhesiveness is preferably also generated initially by the activation. In this variant, the adhesiveness is therefore initially generated by the activation and the single wires are adhered to one another and/or applied to a support in a processing time window, before the curing.

The activation can be implemented thermally, chemically or also by radiation.

The single wires are conventional insulated wires, in which an inner conductor, for example a single wire or a stranded conductor, is directly surrounded by insulation, for example formed from PVC, PP, etc. The insulation is usually extruded on.

The adhesive layer extends continuously in particular over the entire length of the single wires. The adhesive layer runs here preferably continuously and in an uninterrupted manner along the single wires.

In accordance with a preferred embodiment the adhesive layer is applied to the insulation in particular concentrically with a layer thickness in the range from 5 μm to 50 μm and extends in particular continuously over the entire length of the single wires. The adhesive layer is therefore a comparatively thin bonding layer which surrounds the insulation of the single wires. In the present case, the term “adhesive layer” is generally understood to mean any coating acting in the manner of a bonding layer which has an adhesive property so that the two single wires are fixed to one another. If a plurality of single wires are combined, all single wires are thus bonded to one another in this way. Furthermore, a fixing of the electrical cable to a surface of the support on which the cable is to be laid is made possible via the adhesive layer and is provided.

The adhesive is expediently a hot melt which can be thermally activated. The term “hot melt” is understood generally to mean substance systems which melt by heat input (activation), become adhesive, and cure again once cooled.

In accordance with a preferred variant a thermoplastic hot melt is used here, with which a repeated melting is possible. Alternatively, the adhesive is a reactive hot melt, which is preferably adhesive only following an activation and cures in the end state, i.e. is thermally stable.

In a preferred embodiment a reactive adhesive is therefore generally used as adhesive, in which case an irreversible cross linking occurs as a result of a chemical reaction.

Due to the embodiment of the adhesive layer in the form of a curable adhesive, which in particular at least partially cross links as a result of a suitable treatment and is therefore thermally stable, an irreversible bonded connection is preferably achieved between the two single wires. Here, in particular an integrally bonded connection between the insulation of the single wires is produced. Here, an “irreversible connection” is understood to mean that a separation of the single wires is not possible without damaging the insulation. Depending on the adhesive system, it is also possible here that the bonding force is not so great that the single wires cannot be detached from one another again under application of a suitably high force. With the use of a hot melt, the bonding force can be reduced again by heating, such that the single wires can be separated from one another again.

Here, different substances or substance systems can be used for the adhesive layer, for example based on ethylene vinyl acetate (EVA), on polyethylene (PE), on polypropylene (PP), or also on a polyolefin elastomer (POE). In order to achieve the desired properties, the used substance systems are suitably adapted. By way of example, in particular with regard to the desired thermally stable cross linking, an EVA with a vinyl acetate proportion typically in the range of from 7 to approximately 20% by weight is used. The vinyl acetate proportion, however, can also be greater and for example can be up to 60% by weight.

The adhesive layer is preferably applied by spraying or extrusion and in particular is applied as a continuously closed sheath. This allows simple economical production.

In accordance with a preferred embodiment the single wires are twisted with one another. Here, the electrical cable is formed in particular as a data cable. In this case the exact length of lay to be strictly observed is decisive in the twisting. This is ensured via the adhesive layer. Here, in accordance with a first variant, the single wires are twisted with one another to form a pair, as is known in the case of what are known as twisted pair cables. A plurality of single twisted pair wires of this type can be combined to form, as a whole, cable bundles. In addition, there are also other twisted composites, for example star quad twisting, etc.

Twisted (data) cables of this type are preferably used in the automotive field. In this case, an additional shielding, that is to say a shielded sheath, is presently omitted deliberately in order to save costs and weight. The omission of a shielding, however, requires a highly accurate and highly symmetrical twisting, which usually can be maintained in the case of conventional cables only with a cable sheath. In particular, the laying process, in which the cables are subjected to mechanical loading, in particular at bends, is critical here. Due to the permanent bonding of the single wires to one another over their entire length, it is ensured that the set length of lay is maintained over the entire length.

Alternatively to the embodiment of the twisted single wires, these are guided adjacently in parallel in the manner of a flat cable in an expedient embodiment. By contrast to conventional flat cables, however, there is no cable sheath here either, in which the individual cables are embedded.

In an expedient development the cable is formed on the whole as a branched cable, in which at least one single wire branches off from the remaining cable bundle at a defined branch point. The cable is therefore formed in the manner of a cable harness via which a plurality of consumers are connected at different positions, which consumers for example are connected to a common control unit to which the cable bundle leads.

In the automotive field, the cable is often fed through wall regions from a wet area into a dry area. In this feed-through region, a reliable seal is necessary. This is usually provided with what are known as grommets, that is to say plastic-like or rubber-like elements which are arranged or also injection-molded around the cable and seal the cable with respect to an edge of a feed-through opening. In the region of a grommet of this type, there are often problems with regard to longitudinal water tightness, in particular in the case of single wires. Here, it is often difficult to ensure that a sealing compound penetrates between the individual single wires. Now, provision is expediently made for the adhesive layer to be applied sufficiently thick at least in a region and preferably merely in a region, specifically in particular in the region of the sealing element, such that a longitudinal water tightness is achieved. Here, in particular all gaps or interstices inside the cable bundle are reliably filled by the adhesive layer. The adhesive layer is therefore preferably generally applied sufficiently thick at least in this region, such that all free spaces inside the cable bundle are filled with the material of the adhesive layer. The thickness of the adhesive layer in this region is usually in particular much greater here than in the remaining regions of the cable. Here, the necessary thickness is dependent on the material requirement in order to fill up the free spaces, which in turn is dependent for example on the diameter of the single wires and/or the arrangement thereof.

The cable is generally used particularly in a motor vehicle and there is part of the on-board electrical distribution system. Due to the sheath-free embodiment, an economical cable is provided with only low material consumption and low weight compared with a conventional sheathed cable. The cable is preferably a pre-assembled, sheath-free cable, at the end of which at least one plug is attached or an electrical component is directly contacted.

Here, by means of the adhesive layer, the cable is expediently adhered directly on a component of the motor vehicle, which defines a support for the cable. This component by way of example is a body component, such as a support element or a strut. Alternatively, the cable is fastened on a module component, which is installed in the motor vehicle as pre-assembled unit, in particular in conjunction with further functional units (electrical/mechanical). This module component by way of example can be a door module, which supports components such as loudspeakers, window lifters, etc. Alternatively, it is an instrument panel or an instrument panel support or another further module.

In principle, the use is not limited to motor vehicles. The support or the component to which the cable is applied can also be used in other vehicles, aircraft, ships, and also in stationary machines or other installations.

The cable is preferably a current-conducting cable, i.e. is used during operation to supply power to electrical components and is not used for data transmission.

The object is also achieved in accordance with the invention by a single wire with adhesive layer applied thereto. The advantages and preferred embodiments discussed in conjunction with the cable can also be transferred analogously to the single wires. The single wire with the applied adhesive layer is preferably stored ready, for example wound on reels. As necessary, the individual wire is then laid on a support and/or is connected to further single wires, in particular within the scope of a twisting process.

The object is lastly also achieved in accordance with the invention by a method for producing an electrical cable of this type, which cable is formed from a cable bundle formed by at least two single wires, each single wire comprising a conductor surrounded by insulation. Here, before the single wires are joined together, an adhesive layer is applied to the insulation of at least one of the single wires, preferably to all single wires, and the single wires are then joined together to form the cable bundle and are adhered to one another or are adhered to a support via the adhesive layer.

The advantages and preferred embodiments discussed in respect of the electrical cable are also to be transferred analogously to the method. Further preferred embodiments are specified in the depending claims.

Here, the adhesive layer is preferably a reactive coating which cross links once the single wires have been joined together, such that a bond, in particular an irreversibly releasable bond, is provided. The material for the adhesive layer is in particular a reactive one-component adhesive material. The cross linking reaction is triggered here in particular physically, for example by heat input and/or light radiation (UV radiation).

In accordance with an expedient embodiment, the adhesive layer is applied to the insulation of the single wires immediately before the single wires are joined together to form the cable bundle. The adhesive layer is applied and the single wires are joined together therefore within an open time window within which the adhesive, which in particular is a reactive adhesive, can be worked.

In an expedient embodiment the adhesive layer is applied here by extrusion, in particular by co-extrusion or tandem extrusion together with the insulation. Here, the term “co-extrusion” is understood to mean that the insulation of the individual wires and the adhesive layer are applied within one process step by an extrusion tool. Alternatively, there is also the possibility to apply the adhesive layer in a separate extrusion step. Alternatively, the adhesive layer is applied by other application methods, such as dipping, spraying, printing, etc.

The single wires are expediently joined together immediately following the application of the adhesive layer. Here, the single wires are in particular twisted with one another.

In order to achieve a good adhesion of the single wires to one another, the wires are preferably brought into contact with one another or with the support, in particular are pressed against one another, i.e. are pressed against one another or also against the support under the influence of force. This is performed preferably with the aid of a (pressing) tool, which for example is moved relative to the cable bundle. For this purpose, the cable bundle is optionally drawn through the tool, or alternatively the tool is moved along the cable bundle. Alternatively, the single wires are laid in a tool mold and the adhesive layer is adhered therein by activation.

With the aid of the tool, the cross linking of the reactive material is additionally preferably initiated. Here, the tool is for example constituted by a hot air fan, an induction tool, or heating resistors, etc. in order to apply a necessary melting and activation temperature for the initiation of the cross linking reaction. Here, the single wires do not necessarily have to be pressed against one another via the tool. Rather, it is also possible for this to be implemented for example by the twisting process itself to a sufficient extent, i.e. for the forces exerted onto the single wires during the twisting process to be sufficient.

In an expedient embodiment, hot tongs are used as activation tool, which at the same time press the single wires against one another or against the support and additionally initiate the cross linking reaction via an input of heat.

Other features which are considered as characteristic for the invention are set forth in the appended claims.

Although the invention is illustrated and described herein as embodied in an electrical cable and a method for producing an electrical cable bundle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a single wire with adhesive layer applied thereto according to the invention;

FIG. 2 is perspective, detailed view of an electrical cable consisting of a cable bundle having two single wires twisted with one another and adhered to one another;

FIG. 3 is an illustration of a branched electrical cable formed in the manner of a cable harness having a sealing element formed in the manner of a grommet;

FIG. 4 is an exemplary cross-sectional view in a region of the sealing element of FIG. 3; and

FIG. 5 is a block diagram illustrating a production method for producing an electrical cable.

### DETAILED DESCRIPTION OF THE INVENTION

In the drawings, parts having the same effect are provided with the same reference designs.

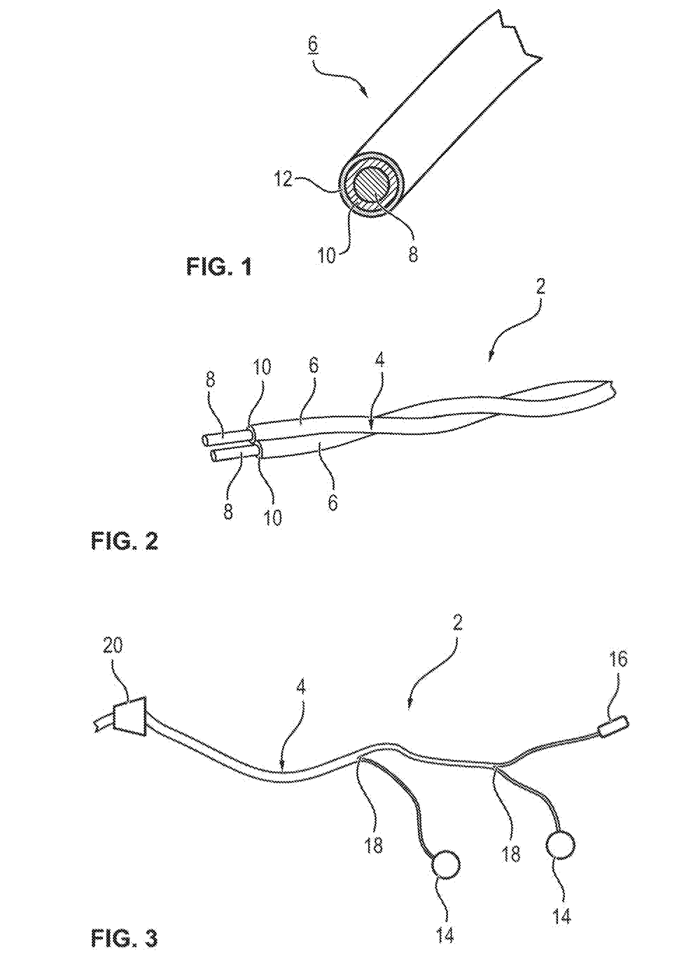

Referring now to the figures of the drawings in detail and first, particularly to FIGS. 1 and 2 thereof, there is shown an electrical cable 2 that contains a cable bundle 4 which is formed from a plurality of individual wires 6, which are preferably twisted with one another.

A single wire 6 of this type is illustrated by way of example in FIG. 1. The single wire 6 is formed from a central inner conductor 8, which is directly surrounded by insulation 10. The insulation 10 is usually applied to the conductor 8 by extrusion. The insulation 10 is in turn surrounded by an adhesive layer 12, which is again applied to the insulation 10 preferably by extrusion. Alternatively, the adhesive layer 12 can also be applied by other application methods. The adhesive layer 12 surrounds the insulation 10 circumferentially and preferably forms a fairly closed annular sheath around the insulation 10. The adhesive layer 12 extends here in particular continuously over the entire length of the single wires 6.

Here, the adhesive layer 12 typically has a thickness in the range of from 5 μm to 50 μm. It therefore usually has a smaller thickness compared to the insulation 10.

The adhesive layer 12 is a reactive coating, in particular a reactive adhesive, which thus cures by a cross linking reaction following an activation and is thus thermally stable.

The material for the adhesive layer 12 is expediently an ethylene vinyl acetate, also referred to as EVA for short. The proportion of vinyl acetate lies here preferably in a range of from 7 to 20% by weight, such that the desired properties are attained. In particular, an EVA of this type, prior to the cross linking, exhibits thermoplastic behavior, and, following initiation and execution of the cross linking reaction, is thermally stable and exhibits thermoset behavior. The temperature for starting the cross linking lies here typically in the range of from 80° C. to 250° C. A material of this type is generally thermoplastic before the onset of the cross linking reaction and therefore can be processed for example by extrusion. Following the application to the insulation 10, the material can cool again and thermoplastically harden, since the cross linking reaction only starts at higher temperatures. The adhesive layer 12 is therefore preferably activated at a time different from that at which the adhesive layer 12 is applied. The single wire provided with the adhesive layer 12 therefore also has good storage stability.

The electrical cable 2 according to FIG. 2 is formed as a twisted pair of two single wires 6. These are fixedly connected to one another via the adhesive layer 12 (not visible here), such that the length of lay set with the twisting process is fixed. This electrical cable 2 is in particular a data cable here. A plurality of single twisted-pair wires 6 of this type can also be combined to form an overall cable bundle 4. The individual pairs here do not necessarily need to be adhered to one another. It is important that the single wires 6 of each particular twisted composite are adhered to one another. It is also possible for all single wires 6 of the pairs to be twisted with one another, such that, on the whole, all single wires 6 of the cable bundle 4 are adhered to one another.

FIG. 3 shows, by way of example, an electrical cable 2 branched in the manner of a cable harness, as are used for example in motor vehicles. By way of example, this cable harness serves for integration in a door module for the electrical attachment of components 14 in the door, such as loudspeakers, window lifters, etc. In FIG. 3, components 14 of this type are illustrated by way of example by circles. The illustrated components 14 are directly connected to the electrical cable 2. A plug connector 16 is also illustrated, via which a further component can be connected via a plug connection.

As can be seen in FIG. 3, the cable bundle 4 has a plurality of branch points 18, at which usually two single wires 6 branch off and lead to the relevant component 14 or to the plug 16. On account of the irreversible adhesive bond, the branch points 18 are already formed with the production of the electrical cable 2, that is to say the individual branched-off single wires 6 are already, at the time of production, separated from the rest of the cable bundle 4 in accordance with their subsequent course and are only adhered to the further single wires 6 as far as the branch point 18.

The cable 2 is preferably directly adhered on a support, for example a pre-fabricated module unit, such as the aforementioned door module, via the adhesive layer 12. There are expediently no further retaining elements provided in order to fix the cable 2 to the support. In particular with the use of a repeatedly meltable hot melt for the adhesive layer 12, the cable 2 is assembled on the support by heating the cable 2 and pressing this against the support.

A branched cable 2 of this type is used, as already mentioned, for example in a door module. Here, it is often necessary for the electrical cable 2 to be guided from a wet region into a dry region. In order to seal a corresponding feed-through opening between these two regions, a sealing element 20 formed in the manner of a grommet is used, which for example is injection-molded or cast around the cable bundle 4. It consists of a suitable plastic or rubber material.

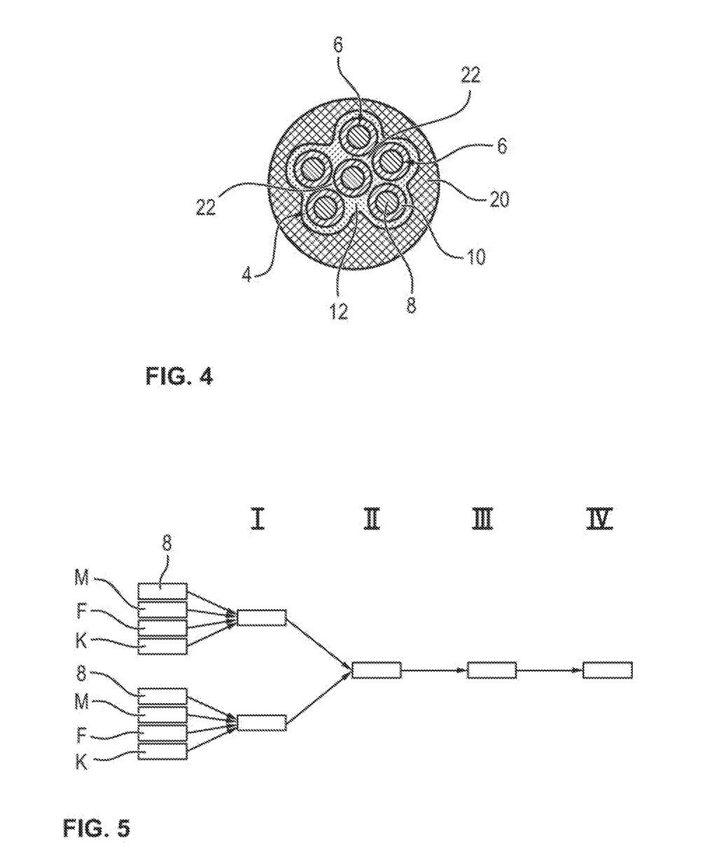

In order to also achieve a longitudinal water tightness between the individual single wires 6, provision is now made with this variant for the adhesive layer 12 to have a sufficient thickness so that all inner gaps 22 between the individual single wires 6 are reliably closed by the material of the adhesive layer 12. This is illustrated by way of example in FIG. 4, which in a simplified manner shows a section through the sealing element 20. As can be clearly seen, a total of six single wires 6 are interconnected to form a cable bundle 4. Two single wires are expediently in each case twisted to form a pair. When the single wires 6 are joined together to form the cable bundle 4, they are preferably pressed against one another and at the same time the material of the adhesive layer 12 is made liquid or viscous under the influence of heat, such that the material of the adhesive layer 12 infiltrates the free spaces between the individual single wires 6 and closes these reliably, such that there are no more open capillaries. Due to the subsequent over molding to form the sealing element 20, a reliable longitudinal water tightness is therefore achieved on the whole.

Alternatively or additionally to the mutual adhesion of the single wires 10 to one another, at least one single wire, preferably a plurality of single wires forming a composite, is adhered to a support (not illustrated here in greater detail). The adhesive layer is activated for this purpose. Here, the single wires 10 do not necessarily need to be adhered to one another, but can also be laid adjacently on the support.

A preferred production method for example for the twisted cable 2 according to FIG. 2 will be explained on the basis of the block diagram of FIG. 5. First, in step I, the single wires 6 are produced by an extrusion process, for example a co-extrusion or tandem extrusion process. Here, the conductors 8, in particular a stranded wire, a first material M for the insulation 12, and adhesive material K, and where necessary a color concentrate F are fed to a tool, in particular an extrusion tool. In this extrusion tool the first material M together with the color concentrate F are firstly extruded onto the conductor 8 in order to form the insulation 10, and the adhesive K is then, or in parallel thereto, extruded as reactive substance onto the extruded-on insulation 10.

This is carried out in an identical manner also for a second single wire 6. In the subsequent method step II the single wires 6 are brought together, in particular twisted with one another, such that the cable bundle 4 is already formed. In the third method step III, the adhesive K is then activated by an input of heat, such that the cross linking reaction is started. This occurs preferably with the aid of an activation tool.

Once the adhesive K has cured, the finished end product, specifically the cable 2, which in particular is a twisted-pair cable, is lastly obtained in step IV.

The following is a summary list of reference numerals and the corresponding structure used in the above description of the invention:

### LIST OF REFERENCE SIGNS

2 electrical cable
4 cable bundle
6 single wire
8 conductor
10 insulation
12 adhesive layer
14 component
16 plug connector
18 branch point
20 sealing element
22 gaps
M first material
K adhesive material
F color concentrate

1. An electrical cable, comprising:
a cable bundle having at least two single wires, each of said single wires containing a conductor and insulation surrounding said conductor, said single wires, in an end assembled state, are adhered to one another or are adhered to a support; and
an adhesive directly applied at least to said insulation of one of said single wires to form an adhesive layer surrounding said insulation in a sheath-like manner, via said adhesive layer said single wires are adhered to one another or are adhered to the support, said adhesive is formed as an activatable and curable adhesive, which becomes adhesive and/or is cured only following an activation, and in that said cable bundle in the end assembled state does not have a surrounding cable sheath.

2. The electrical cable according to claim 1, wherein said adhesive layer is applied to said insulation with a layer thickness in a range of from 5 μm to 50 μm over an entire length of said single wires.

3. The electrical cable according to claim 1, wherein said adhesive is a hot melt which can be thermally activated.

4. The electrical cable according to claim 1, wherein said adhesive layer is a reactive coating which is adhesive following the activation and is cured in the end assembled state.

5. The electrical cable according to claim 1, wherein said adhesive layer is formed as a closed sheath extruded or sprayed onto said insulation.

6. The electrical cable according to claim 1, wherein said single wires are twisted with one another.

7. The electrical cable according to claim 1, wherein the electric cable is formed as a branched cable and at least one single wire branches off at a defined branch point.

8. The electrical cable according to claim 1, wherein gaps between said single wires within said cable bundle are filled fully by a material of said adhesive layer at least in one region.

9. The electrical cable according to claim 1, wherein the electrical cable is laid in a sheath-free manner within a motor vehicle.

10. The electrical cable according to claim 1, wherein the electrical cable is adhered directly to a component of a motor vehicle via said adhesive layer.

11. The electrical cable according to claim 1, wherein the electrical cable is directly adhered to a component of a motor vehicle via said adhesive layer.

12. The electrical cable according to claim 1, wherein said single wires are used as current-conducting wires and are not used for data transmission.

13. A single wire, comprising:
a conductor;
an insulation surrounding said conductor; and
an adhesive directly applied to said insulation for forming an adhesive layer surrounding said insulation in a sheath-like manner, via said adhesive layer the single wire can be adhered to a further single wire or to a support, wherein said adhesive is formed as an activatable and curable adhesive which first becomes adhesive and/or cures only following an activation.

14. The single wire according to claim 1, wherein the single wire is provided for a further process step in a manner stored with an inactivated adhesive layer on a reel.

15. The single wire according to claim 15, wherein the further process step is a twisting step.

16. A method for producing an electrical cable bundle, which comprises the steps of:
providing at least two single wires, each of the single wires containing a conductor surrounded by insulation; and
applying an adhesive directly at least to the insulation of one of the single wires to form an adhesive layer surrounding the insulation in a sheath-like manner adhesive, before the single wires are joined together to form the electrical cable bundle, wherein the adhesive is formed as an activatable and curable adhesive and the single wires are joined together to form the cable bundle and are adhered to one another or are adhered to a support via the adhesive layer in that the adhesive becomes adhesive and/or cures by activation.

17. The method according to claim 16, which further comprises providing a hot melt as the adhesive, the hot melt is thermally activated, and/or in that the adhesive layer is a reactive coating which cross-links once the single wires have been joined together.

18. The method according to claim 16, which further comprises applying the adhesive layer to the insulation immediately before the single wires are joined together.

19. The method according to claim 16, which further comprises applying the adhesive layer to the insulation by extrusion or by spraying together with the insulation.

20. The method according to claim 16, which further comprises twisting the single wires with one another.

21. The method according to claim 16, which further comprises bringing the single wires into contact during a curing of the adhesive layer.

22. The method according to claim 19, which further comprises applying the adhesive layer to the insulation by co-extrusion together with the insulation.

23. The method according to claim 16, which further comprises bringing the single wires into contact and pressed against one another or against the support during a curing of the adhesive layer.
